(19) United States
(12) Patent Application Publication
(10) Pub. No.: US 2025/0233640 A1
(43) Pub. Date: Jul. 17, 2025

(54) SYSTEMS AND METHODS FOR QUASI-CO-POLARIZATION DIRECTION INDICATION WITH DUAL-POLARIZED ANTENNAS

(71) Applicant: Huawei Technologies Co., Ltd., Shenzhen (CN)

(72) Inventors: Xi Zhang, Beijing (CN); Wen Tong, Ottawa (CA); Xiaoyan Bi, Shanghai (CN); Jianglei Ma, Ottawa (CA)

(21) Appl. No.: 19/170,567

(22) Filed: Apr. 4, 2025

Related U.S. Application Data
(63) Continuation of application No. PCT/CN2022/125119, filed on Oct. 13, 2022.

(51) Int. Cl. H04B 7/06; H04B 7/10; H04L 5/00; H04W 56/00; H04W 74/0833

(52) U.S. Cl. CPC H04B 7/06952; H04B 7/10; H04L 5/0051; H04W 56/0015; H04W 74/0833

(57) ABSTRACT

Aspects of the present disclosure are directed to an indication of polarization direction association that indicates an association between a first resource with at least 1 port and a second resource with at least 1 port or between a first resource with at least 1 port and a first port of a second resource with at least 1 port to assist a user equipment (UE) in matching polarization direction with a base station in downlink (DL) reception or uplink (UL) transmission. The first resource may be one of CSI-RS, PDCCH, PDSCH, PUCCH, PUSCH, SRS, or PRACH. The second resource may be one of an SSB, CSI-RS, SRS or PRACH, and the SSB may comprise one or more of PSS, SSS, PBCH, and DMRS for PBCH. Other aspects may include group-based partitioning of antenna ports within a first resource and a second resource for providing a quasi-co-polarization direction association.

### CROSS REFERENCE

The present application is a continuation of International Application No. PCT/CN2022/125119, filed on Oct. 13, 2022, the disclosure of which is hereby incorporated by reference in its entirety.

### TECHNICAL FIELD

The present disclosure relates generally to wireless communications, and in particular to systems and methods for supporting a quasi-co-polarization direction indication with dual-polarized antennas.

### BACKGROUND

In Fifth Generation (5G) New Radio (NR), a synchronization signal-physical broadcast channel (SS-PBCH) block (SSB) is transmitted with one antenna port, i.e. antenna port p=4000 is used for transmission of primary synchronization signal (PSS), secondary synchronization signal (SSS), physical broadcast channel (PBCH) and demodulation reference signal (DM-RS) for PBCH. An antenna port is a virtual concept and is not necessarily equivalent to transmission on a given antenna. For example, a base station (BS) may use two antennas to transmit one antenna port. A user equipment (UE) may have no knowledge of antenna architecture at the base station or how such 1-port SSB is transmitted via one or more antennas at the base station.

At frequencies in the millimeter wave (mmWave) range (e.g., 26, 38, 39, 73 GHZ) and the mid-band range (e.g., 3.5, 3.7, 4.7, 4.9 GHZ), dual-polarized antennas are widely used at the base station and the UE. With dual-polarized antennas, two linearly polarized antennas are often superposed on a same location, but separated by about 90 degrees in the polarization direction, for example, vertical and horizontal polarization directions or +45 degree slant polarization directions. With dual-polarized antennas, independent signals can be transmitted from antennas with different polarization directions. There may be multiple antennas corresponding to the same polarization direction, for example, the first and second groups of antennas for vertical and horizontal polarization directions or +45 degree slant polarization directions, respectively. In this case, one antenna over vertical or −45-degree slant polarization direction may be superposed with one antenna over horizontal or +45-degree slant polarization direction. It is also possible that the first and second groups of antennas for vertical and horizontal polarization directions or +45 degree slant polarization directions are located separately, e.g., the first group of antennas at one location and the second group of antennas at another location. In such cases, the number of antennas in the first and the second groups of antennas can be same or different.

In 5G NR, a quasi-co-location (QCL) type, QCL typeD, was introduced to support beam indication. QCL typeD, which is defined as spatial receiver (Rx) parameter, is configured by a base station to help a UE determine an appropriate UE receive or transmit beam to communicate with the base station. The QCL typeD parameter may include a reference signal (RS) transmitted by the base station, that the UE has previously measured and reported to the base station. In the report from the UE to the base station, the RS resource index represents the transmit beam at the base station leading to the corresponding reported quality. After a target signal or target channel is indicated with QCL typeD parameter, which contains a source RS (also known as QCL source RS), the UE assumes the target signal or target channel is typeD quasi-co-located (QCLed) to the indicated source RS. In other words, the UE may use a receive beam that was used for receiving the source RS to receive the target signal or target channel. As can be seen, the terms of source and target are used to indicate the direction of QCL relation, i.e. the target is QCLed with the source. In a broader sense of QCL relation, the source may also be considered as QCLed to the target. In subsequent discussions, when there is no ambiguity, the terms of source and target are omitted for brevity.

### SUMMARY

In some embodiments, aspects of the present disclosure may result in reduced UE complexity for selecting dual polarized antennas for DL reception or UL transmission.

In some embodiments, aspects of the present disclosure may result in improved CSI measurement accuracy and DL detection performance at the UE with more knowledge of base station polarization direction(s) and antenna architecture.

In some embodiments, aspects of the present disclosure may result in reduced base station and UE power consumption with only selected polarized antenna(s) to transmit or receive.

In some embodiments, aspects of the present disclosure may result in on-demand extra robustness against polarization mismatch from UE rotation when needed.

During the design of QCL typeD parameter, polarization direction of a signal or channel was not considered. According to some aspects of the disclosure there is provided a method involving receiving an indication of a quasi co-polarization-direction (QCPD) association between a first resource with at least 1 port and a second resource with at least 1 port or between a first resource with at least 1 port and a first port of a second resource with at least 1 port; and wherein the first resource is one of a channel state information reference signal (CSI-RS), a physical downlink control channel (PDCCH), a physical downlink shared channel (PDSCH), a physical uplink control channel (PUCCH), a physical uplink shared channel (PUSCH), a sounding reference signal (SRS), or a physical random access channel (PRACH); and where the second resource is one of a synchronization signal-physical broadcast channel block (SSB), CSI-RS, SRS, or PRACH, and wherein the SSB may comprise one or more of primary synchronization signal (PSS), secondary synchronization signal (SSS), physical broadcast channel (PBCH), and demodulation reference signal (DMRS) for PBCH.

In some embodiments, the first resource with at least 1 port is a first resource with X ports, where X is an integer, and the second resource with at least 1 port is a second resource with 2 ports.

In some embodiments, the QCPD association between the first resource with X ports and the second resource with 2 ports further comprises an indication of at least one of: even-indexed ports of the first resource with X ports are transmitted or received with the same polarization direction of a first port of the second resource with 2 ports; or odd-indexed ports of the first resource with X ports are transmitted or received with the same polarization direction of a second port of the second resource with 2 ports.

In some embodiments, the QCPD association between the first resource with X ports and the second resource with 2 ports further comprises an indication of at least one of: a first half of the ports of the first resource with X ports are transmitted or received with the same polarization direction of a first port of the second resource with 2 ports; or a second half of the ports of the first resource with X ports are transmitted or received with the same polarization direction of a second port of the second resource with 2 ports.

In some embodiments, the first resource with at least 1 port is a first resource with Y ports, where Y is an integer, and the first port of the second resource with at least 1 port is a first port of a second resource with 2 ports.

In some embodiments, the QCPD association between the first resource with Y ports and the first port of a second resource with 2 ports further comprises an indication of: the ports of the first resource with Y ports are transmitted or received with the same polarization direction of the first port of the second resource with 2 ports.

In some embodiments, the first resource with at least 1 port is a first resource with 1 port and the second resource with at least 1 port is a second resource with 2 ports.

In some embodiments, the QCPD association between the first resource with 1 port and the second resource with 2 ports further comprises an indication of: the first resource with 1 port is transmitted or received with the same two polarization directions used for transmitting or receiving the second resource with 2 ports.

In some embodiments, the polarization direction is one of: vertical polarization direction; or horizontal polarization direction; or −45 degree slant polarization direction; or +45 degree slant polarization direction.

In some embodiments, the two polarization directions are: vertical and horizontal polarization directions; or −45 and +45 degree slant polarization directions.

According to some aspects of the disclosure there is provided a device including a processor and a computer-readable storage media. The computer-readable storage media has stored thereon, computer executable instructions, that when executed by the processor, perform a method as described above or detailed below.

According to some aspects of the disclosure there is provided a method involving receiving an indication of polarization direction for a resource with at least 1 port, wherein the resource is one of a channel state information reference signal (CSI-RS), a physical downlink control channel (PDCCH), a physical downlink shared channel (PDSCH), a physical uplink control channel (PUCCH), a physical uplink shared channel (PUSCH), a sounding reference signal (SRS), a physical random access channel (PRACH), or a synchronization signal-physical broadcast channel block (SSB); and wherein the resource with at least 1 port is a resource with L ports, where L is an integer, and even-indexed ports in the resource with L ports are transmitted or received via base station antennas or user equipment (UE) antennas on a first polarization direction, and odd-indexed ports in the resource with L ports are transmitted or received via the base station antennas or the UE antennas on a second polarization direction; or the resource with at least 1 port is a resource with M ports, where M is an integer, and a first half of ports in the resource with M ports are transmitted or received via base station antennas or UE antennas on a first polarization direction, and a second half of ports in the resource with M ports are transmitted or received via the base station antennas or the UE antennas on a second polarization direction; or the resource with at least 1 port is a resource with N ports, where N is an integer, and the ports in the resource with N ports are transmitted or received via base station antennas or UE antennas on a first polarization direction; or the resource with at least 1 port is a resource with 1 port, and the resource with 1 port is transmitted or received via base station antennas or UE antennas on two polarization directions.

In some embodiments, the first polarization direction and the second polarization direction are each one of: vertical polarization direction; horizontal polarization direction; −45 degree slant polarization direction; or +45 degree slant polarization direction; and wherein the two polarization directions are: vertical and horizontal polarization directions; or −45 degree and +45 degree slant polarization directions.

According to some aspects of the disclosure there is provided a device including a processor and a computer-readable storage media. The computer-readable storage media has stored thereon, computer executable instructions, that when executed by the processor, perform a method as described above or detailed below.

According to some aspects of the disclosure there is provided a method involving transmitting an indication of a quasi co-polarization-direction (QCPD) association between a first resource with at least 1 port and a second resource with at least 1 port or between a first resource with at least 1 port and a first port of a second resource with at least 1 port; and wherein the first resource is one of a channel state information reference signal (CSI-RS), a physical downlink control channel (PDCCH), a physical downlink shared channel (PDSCH), a physical uplink control channel (PUCCH), a physical uplink shared channel (PUSCH), a sounding reference signal (SRS), or a physical random access channel (PRACH); and where the second resource is one of a synchronization signal-physical broadcast channel block (SSB), CSI-RS, SRS, or PRACH, and wherein the SSB may comprise one or more of primary synchronization signal (PSS), secondary synchronization signal (SSS), physical broadcast channel (PBCH), and demodulation reference signal (DMRS) for PBCH.

In some embodiments, the first resource with at least 1 port is a first resource with X ports, where X is an integer, and the second resource with at least 1 port is a second resource with 2 ports.

In some embodiments, the QCPD association between the first resource with X ports and the second resource with 2 ports further comprises an indication of at least one of: even-indexed ports of the first resource with X ports are transmitted or received with the same polarization direction of a first port of the second resource with 2 ports; or odd-indexed ports of the first resource with X ports are transmitted or received with the same polarization direction of a second port of the second resource with 2 ports.

In some embodiments, the QCPD association between the first resource with X ports and the second resource with 2 ports further comprises an indication of at least one of: a first half of the ports of the first resource with X ports are transmitted or received with the same polarization direction of a first port of the second resource with 2 ports; or a second half of the ports of the first resource with X ports are transmitted or received with the same polarization direction of a second port of the second resource with 2 ports.

In some embodiments, the first resource with at least 1 port is a first resource with Y ports, where Y is an integer, and the first port of the second resource with at least 1 port is a first port of a second resource with 2 ports.

In some embodiments, the QCPD association between the first resource with Y ports and the first port of a second resource with 2 ports further comprises an indication of: the ports of the first resource with Y ports are transmitted or received with the same polarization direction of the first port of the second resource with 2 ports.

In some embodiments, the first resource with at least 1 port is a first resource with 1 port and the second resource with the at least 1 port is a second resource with 2 ports.

In some embodiments, the QCPD association between the first resource with 1 port and the second resource with 2 ports further comprises an indication of: the first resource with 1 port is transmitted or received with the same two polarization directions used for transmitting or receiving the second resource with 2 ports.

In some embodiments, the polarization direction is one of: vertical polarization direction; or horizontal polarization direction; or −45 degree slant polarization direction; or +45 degree slant polarization direction.

In some embodiments, the two polarization directions are: vertical and horizontal polarization directions; or −45 and +45 degree slant polarization directions.

According to some aspects of the disclosure there is provided a device including a processor and a computer-readable storage media. The computer-readable storage media has stored thereon, computer executable instructions, that when executed by the processor, perform a method as described above or detailed below.

According to some aspects of the disclosure there is provided a method involving transmitting an indication of polarization direction for a resource with at least 1 port, wherein the resource is one of a channel state information reference signal (CSI-RS), a physical downlink control channel (PDCCH), a physical downlink shared channel (PDSCH), a physical uplink control channel (PUCCH), a physical uplink shared channel (PUSCH), a sounding reference signal (SRS), a physical random access channel (PRACH) or a synchronization signal-physical broadcast channel block (SSB); and wherein the resource with at least 1 port is a resource with L ports, where L is an integer, and even-indexed ports in the resource with L ports are transmitted or received via base station antennas or user equipment (UE) antennas on a first polarization direction, and odd-indexed ports in the resource with L ports are transmitted or received via the base station antennas or the UE antennas on a second polarization direction; or the resource with at least 1 port is a resource with M ports, where M is an integer, and a first half of ports in the resource with M ports are transmitted or received via base station antennas or UE antennas on a first polarization direction, and a second half of ports in the resource with M ports are transmitted or received via the base station antennas or the UE antennas on a second polarization direction; or the resource with at least 1 port is a resource with N ports, where N is an integer, and the ports in the resource with N ports are transmitted or received via base station antennas or UE antennas on a first polarization direction; or the resource with at least 1 port is a resource with 1 port, and the resource with 1 port is transmitted or received via base station antennas or UE antennas on two polarization directions.

In some embodiments, the first polarization direction and the second polarization direction are each one of: vertical polarization direction; horizontal polarization direction; −45 degree slant polarization direction; or +45 degree slant polarization direction; and wherein the two polarization directions are: vertical and horizontal polarization directions; or −45 degree and +45 degree slant polarization directions.

According to some aspects of the disclosure there is provided a device including a processor and a computer-readable storage media. The computer-readable storage media has stored thereon, computer executable instructions, that when executed by the processor, perform a method as described above or detailed below.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1A is a schematic diagram of a communication system in which embodiments of the present disclosure may occur.

FIG. 1B is another schematic diagram of a communication system in which embodiments of the present disclosure may occur.

FIG. 2 is a block diagram illustrating units or modules in a device in which embodiments of the present disclosure may occur.

FIG. 3 is a block diagram illustrating units or modules in a device in which embodiments of the present disclosure may occur.

FIG. 4 is a schematic diagram illustrating transmission and reception of a 1-port SSB with dual-polarized antennas.

FIG. 5 illustrates an example of a signal flow diagram between a network device and an apparatus, such as a UE, that enables reduced latency between SSB detection and multiple input multiple output (MIMO) transmission using a channel state information (CSI) report transmitted over physical uplink shared channel (PUSCH), such as a Msg3 PUSCH, in accordance with embodiments of the present disclosure.

FIG. 6 is a schematic diagram of a portion of a network including a base station and a UE used to illustrate a quasi-co-polarization direction (QCPD) association between a 16-port channel state information reference signal (CSI-RS) resource and a 2-port SSB resource according to an aspect of the present disclosure.

FIG. 7 is a schematic diagram of a portion of a network including a base station and a UE used to illustrate a QCPD association between an 8-port CSI-RS resource and one port in a 2-port SSB resource according to an aspect of the present disclosure.

FIG. 8 is a schematic diagram of a portion of a network including a base station and a UE used to illustrate a QCPD association between a 1-port CSI-RS resource and a 2-port SSB resource according to an aspect of the present disclosure.

FIG. 9 is a representation illustrating a reciprocal QCPD association between PUCCH or PUSCH or SRS and SSB or CSI-RS according to an aspect of the present disclosure.

FIG. 10 illustrates an example of a signal flow diagram for transmission of configuration information related to quasi-co-polarization direction association, in accordance with embodiments of the present disclosure.

### DETAILED DESCRIPTION

For illustrative purposes, specific example embodiments will now be explained in greater detail below in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e. DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

Aspects of the present disclosure are directed to an indication of polarization direction association that indicates an association between a first resource with at least 1 port and a second resource with at least 1 port or between a first resource with at least 1 port and a first port of a second resource with at least 1 port in terms of polarization direction to assist the UE in matching polarization direction with the base station in downlink (DL) reception or uplink (UL) transmission. In some embodiments, the first resource is one of a channel state information reference signal (CSI-RS), a physical downlink control channel (PDCCH), a physical downlink shared channel (PDSCH), a physical uplink control channel (PUCCH), a physical uplink shared channel (PUSCH), or a sounding reference signal (SRS). In some embodiments, the second resource is one of a synchronization signal-physical broadcast channel block (SSB), CSI-RS, SRS, or PRACH, and wherein the SSB may comprise one or more of primary synchronization signal (PSS), secondary synchronization signal (SSS), physical broadcast channel (PBCH), and demodulation reference signal (DMRS) for PBCH. A particular example may include an association between a CSI-RS resource and an SSB resource or an SSB port. During measurement of 2-port SSB, where each SSB port is transmitted over one polarization direction in relation to the surface of the earth or is transmitted via base station antennas corresponding to one polarization direction, the UE obtains knowledge of how the UE may use the UE dual-polarized antennas to receive signals transmitted over dual-polarized antennas at the base station to maximize per-SSB-port signal-to-interference-plus-noise ratio (SINR), e.g., to switch its dual-polarized antennas, possible combining of signals received from dual-polarized antennas. With indication of polarization direction association from the base station, the UE may assume that CSI-RS is transmitted with same or similar polarization direction(s) as the associated SSB. Therefore, the UE may receive CSI-RS following a similar reception behavior as receiving the associated SSB. In other words, the base station indication of a quasi-co-polarization direction (QCPD) association between SSB and CSI-RS may help subsequent CSI-RS reception at the UE, e.g., selecting from dual-polarized antennas, combining signals from dual-polarized antennas.

Aspects of the present disclosure also include group-based partitioning of antenna ports within a first resource and/or a second resource for providing a quasi-co-polarization direction association.

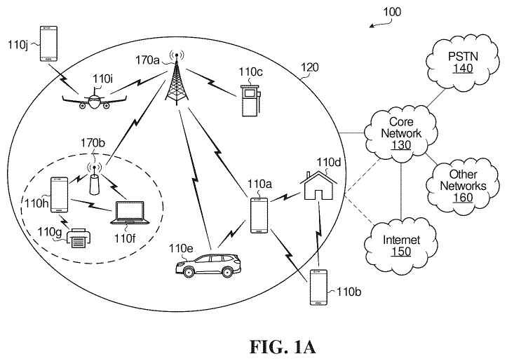

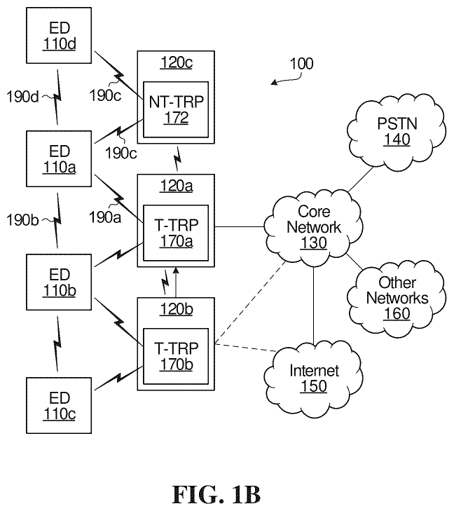

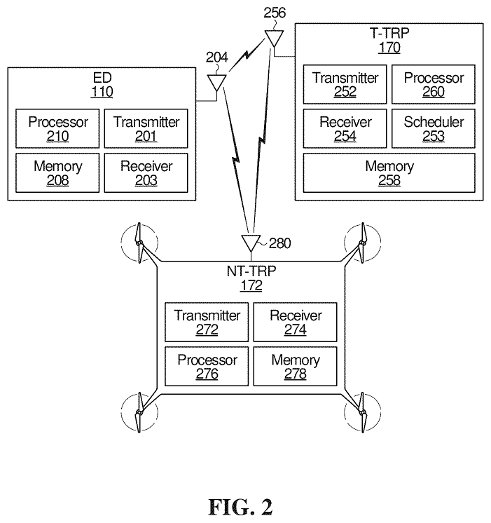

FIGS. 1A, 1B, and 2 following below provide context for the network and device that may be in the network and that may implement aspects of the present disclosure.

Referring to FIG. 1A, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another, and may also or instead be connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

FIG. 1B illustrates an example communication system 100 in which embodiments of the present disclosure could be implemented. In general, the system 100 enables multiple wireless or wired elements to communicate data and other content. The purpose of the system 100 may be to provide content (voice, data, video, text) via broadcast, narrowcast, user device to user device, etc. The system 100 may operate efficiently by sharing resources such as bandwidth.

In this example, the communication system 100 includes electronic devices (ED) 110a-110c, radio access networks (RANs) 120a-120b, a core network 130, a public switched telephone network (PSTN) 140, the Internet 150, and other networks 160. While certain numbers of these components or elements are shown in FIG. 1B, any reasonable number of these components or elements may be included in the system 100.

The EDs 110a-110c are configured to operate, communicate, or both, in the system 100. For example, the EDs 110a-110c are configured to transmit, receive, or both via wireless communication channels. Each ED 110a-110c represents any suitable end user device for wireless operation and may include such devices (or may be referred to) as a user equipment/device (UE), wireless transmit/receive unit (WTRU), mobile station, mobile subscriber unit, cellular telephone, station (STA), machine type communication device (MTC), personal digital assistant (PDA), smartphone, laptop, computer, touchpad, wireless sensor, or consumer electronics device.

FIG. 1B illustrates an example communication system 100 in which embodiments of the present disclosure could be implemented. In general, the communication system 100 enables multiple wireless or wired elements to communicate data and other content. The purpose of the communication system 100 may be to provide content (voice, data, video, text) via broadcast, multicast, unicast, user device to user device, etc. The communication system 100 may operate by sharing resources such as bandwidth.

In this example, the communication system 100 includes electronic devices (ED) 110a-110d, radio access networks (RANs) 120a-120c, a core network 130, a public switched telephone network (PSTN) 140, the internet 150, and other networks 160. Although certain numbers of these components or elements are shown in FIG. 1B, any reasonable number of these components or elements may be included in the communication system 100.

The EDs 110a-110d are configured to operate, communicate, or both, in the communication system 100. For example, the EDs 110a-110d are configured to transmit, receive, or both, via wireless or wired communication channels. Each ED 110a-110d represents any suitable end user device for wireless operation and may include such devices (or may be referred to) as a user equipment/device (UE), wireless transmit/receive unit (WTRU), mobile station, fixed or mobile subscriber unit, cellular telephone, station (STA), machine type communication (MTC) device, personal digital assistant (PDA), smartphone, laptop, computer, tablet, wireless sensor, or consumer electronics device.

In FIG. 1B, the RANs 120a-120b include base stations 170a-170b, respectively. Each base station 170a-170b is configured to wirelessly interface with one or more of the EDs 110a-110c to enable access to any other base station 170a-170b, the core network 130, the PSTN 140, the internet 150, and/or the other networks 160. For example, the base stations 170a-170b may include (or be) one or more of several well-known devices, such as a base transceiver station (BTS), a Node-B (NodeB), an evolved NodeB (eNodeB), a Home eNodeB, a gNodeB, a transmission and receive point (TRP), a site controller, an access point (AP), or a wireless router.

In some examples, one or more of the base stations 170a-170b may be a terrestrial base station that is attached to the ground. For example, a terrestrial base station could be mounted on a building or tower. Alternatively, one or more of the base stations 172 may be a non-terrestrial base station, or non-terrestrial TRP (NT-TRP), that is not attached to the ground. A flying base station is an example of the non-terrestrial base station. A flying base station may be implemented using communication equipment supported or carried by a flying device. Non-limiting examples of flying devices include airborne platforms (such as a blimp or an airship, for example), balloons, quadcopters and other aerial vehicles. In some implementations, a flying base station may be supported or carried by an unmanned aerial system (UAS) or an unmanned aerial vehicle (UAV), such as a drone or a quadcopter. A flying base station may be a moveable or mobile base station that can be flexibly deployed in different locations to meet network demand. A satellite base station is another example of a non-terrestrial base station. A satellite base station may be implemented using communication equipment supported or carried by a satellite. A satellite base station may also be referred to as an orbiting base station.

Any ED 110a-110d may be alternatively or additionally configured to interface, access, or communicate with any other base station 170a-170b, the internet 150, the core network 130, the PSTN 140, the other networks 160, or any combination of the preceding.

The EDs 110a-110d and base stations 170a-170b, 172 are examples of communication equipment that can be configured to implement some or all of the operations and/or embodiments described herein. In the embodiment shown in FIG. 1B, the base station 170a forms part of the RAN 120a, which may include other base stations, base station controller(s) (BSC), radio network controller(s) (RNC), relay nodes, elements, and/or devices. Any base station 170a, 170b may be a single element, as shown, or multiple elements, distributed in the corresponding RAN, or otherwise. Also, the base station 170b forms part of the RAN 120b, which may include other base stations, elements, and/or devices. Each base station 170a-170b transmits and/or receives wireless signals within a particular geographic region or area, sometimes referred to as a “cell” or “coverage area”. A cell may be further divided into cell sectors, and a base station 170a-170b may, for example, employ multiple transceivers to provide service to multiple sectors. In some embodiments, there may be established pico or femto cells where the radio access technology supports such. In some embodiments, multiple transceivers could be used for each cell, for example using multiple-input multiple-output (MIMO) technology. The number of RAN 120a-120b shown is exemplary only. Any number of RAN may be contemplated when devising the communication system 100.

The base stations 170a-170b, 172 communicate with one or more of the EDs 110a-110c over one or more air interfaces 190a, 190c using wireless communication links e.g. radio frequency (RF), microwave, infrared (IR), etc. The air interfaces 190a, 190c may utilize any suitable radio access technology. For example, the communication system 100 may implement one or more orthogonal or non-orthogonal channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a, 190c.

A base station 170a-170b, 172 may implement Universal Mobile Telecommunication System (UMTS) Terrestrial Radio Access (UTRA) to establish an air interface 190a, 190c using wideband CDMA (WCDMA). In doing so, the base station 170a-170b.172 may implement protocols such as High Speed Packet Access (HSPA), Evolved HPSA (HSPA+) optionally including High Speed Downlink Packet Access (HSDPA), High Speed Packet Uplink Access (HSPUA) or both. Alternatively, a base station 170a-170b,172 may establish an air interface 190a,190c with Evolved UTMS Terrestrial Radio Access (E-UTRA) using LTE, LTE-A, and/or LTE-B. It is contemplated that the communication system 100 may use multiple channel access operation, including such schemes as described above. Other radio technologies for implementing air interfaces include IEEE 802.11, 802.15, 802.16, CDMA2000, CDMA2000 1×, CDMA2000 EV-DO, IS-2000, IS-95, IS-856, GSM, EDGE, and GERAN. Of course, other multiple access schemes and wireless protocols may be utilized.

The RANs 120a-120b are in communication with the core network 130 to provide the EDs 110a-110c with various services such as voice, data, and other services. The RANs 120a-120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a-120b or EDs 110a-110c or both, and (ii) other networks (such as the PSTN 140, the internet 150, and the other networks 160).

The EDs 110a-110d communicate with one another over one or more sidelink (SL) air interfaces 190b, 190d using wireless communication links e.g. radio frequency (RF), microwave, infrared (IR), etc. The SL air interfaces 190b, 190d may utilize any suitable radio access technology, and may be substantially similar to the air interfaces 190a, 190c over which the EDs 110a-110c communication with one or more of the base stations 170a-170b, or they may be substantially different. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the SL air interfaces 190b, 190d. In some embodiments, the SL air interfaces 180 may be, at least in part, implemented over unlicensed spectrum.

In addition, some or all of the EDs 110a-110d may include operation for communicating with different wireless networks over different wireless links using different wireless technologies and/or protocols. Instead of wireless communication (or in addition thereto), the EDs may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as internet protocol (IP), transmission control protocol (TCP) and user datagram protocol (UDP). EDs 110a-110d may be multimode devices capable of operation according to multiple radio access technologies, and incorporate multiple transceivers necessary to support multiple radio access technologies.

In some embodiments, the signal is transmitted from a terrestrial BS to the UE or transmitted from the UE directly to the terrestrial BS and in both cases the signal is not reflected by a RIS. However, the signal may be reflected by the obstacles and reflectors such as buildings, walls and furniture. In some embodiments, the signal is communicated between the UE and a non-terrestrial BS such as a satellite, a drone and a high altitude platform. In some embodiments, the signal is communicated between a relay and a UE or a relay and a BS or between two relays. In some embodiments, the signal is transmitted between two UEs. In some embodiments, one or multiple RIS are utilized to reflect the signal from a transmitter and a receiver, where any of the transmitter and receiver includes UEs, terrestrial or non-terrestrial BS, and relays.

FIG. 2 illustrates another example of an ED 110 and network devices, including a base station 170a, 170b (at 170) and an NT-TRP 172. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IoT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

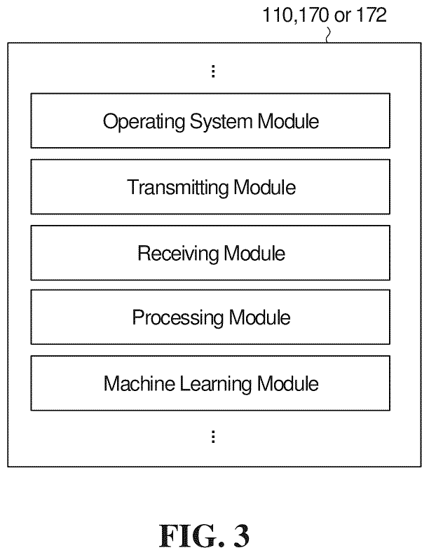

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 2A or 2B). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 210 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distributed unit (DU), positioning node, among other possibilities. The T-TRP 170 may be macro BSs, pico BSs, relay node, donor node, or the like, or combinations thereof. The T-TRP 170 may refer to the forging devices, or to apparatus (e.g. communication module, modem, or chip) in the forgoing devices. While the figures and accompanying description of example and embodiments of the disclosure generally use the terms AP, BS, and AP or BS, it is to be understood that such device could be any of the types described above.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. multiple-input multiple-output (MIMO) precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

One or more steps of the embodiment methods provided herein may be performed by corresponding units or modules, according to FIG. 3. FIG. 3 illustrates units or modules in a device, such as in ED 110, in T-TRP 170, or in NT-TRP 172. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

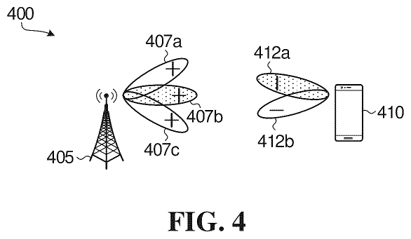

One or more steps of the embodiment methods provided herein may be performed by corresponding units or modules, according to FIG. 4. FIG. 4 illustrates units or modules in a device, such as in ED 110, in T-TRP 170, or in NT-TRP 172. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

For future wireless networks, a number of the new devices could increase exponentially with diverse functionalities. Also, many new applications and new use cases in future wireless networks than existing in 5G may emerge with more diverse quality of service demands. These will result in new key performance indications (KPIs) for the future wireless network (for an example, 6G network) that can be extremely challenging, so the sensing technologies, and AI technologies, especially ML (deep learning) technologies, had been introduced to telecommunication for improving the system performance and efficiency.

AI/ML technologies applied communication including AI/ML communication in Physical layer and AI/ML communication in media access control (MAC) layer. For physical layer, the AI/ML communication may be useful to optimize the components design and improve the algorithm performance, like AI/ML on channel coding, channel modelling, channel estimation, channel decoding, modulation, demodulation, MIMO, waveform, multiple access, PHY element parameter optimization and update, beam forming & tracking and sensing & positioning, etc. For MAC layer, AI/ML communication may utilize the AI/ML capability with learning, prediction and make decisions to solve the complicated optimization problems with better strategy and optimal solution, for example to optimize the functionality in MAC, e.g. intelligent TRP management, intelligent beam management, intelligent channel resource allocation, intelligent power control, intelligent spectrum utilization, intelligent modulation and coding scheme (MCS), intelligent hybrid automatic repeat request (HARQ) strategy, intelligent transmit/receive (Tx/Rx) mode adaption, etc.

AI/ML architectures usually involve multiple nodes, which can be organized in two modes, i.e., centralized and distributed, both of which can be deployed in access network, core network, or an edge computing system or third-party network. The centralized training and computing architecture is restricted by huge communication overhead and strict user data privacy. Distributed training and computing architecture comprise several frameworks, e.g., distributed machine learning and federated learning. AI/ML architectures comprises intelligent controller which can perform as single agent or multi-agent, based on joint optimization or individual optimization. A new protocol and signaling mechanism is needed so that the corresponding interface link can be personalized with customized parameters to meet particular requirements while minimizing signaling overhead and maximizing the whole system spectrum efficiency by personalized AI technologies.

Further terrestrial and non-terrestrial networks can enable a new range of services and applications such as earth monitoring, remote sensing, passive sensing and positioning, navigation, and tracking, autonomous delivery and mobility. Terrestrial networks based sensing and non-terrestrial networks based sensing could provide intelligent context-aware networks to enhance the UE experience. For example, terrestrial networks based sensing and non-terrestrial networks based sensing may involve opportunities for localization and sensing applications based on a new set of features and service capabilities. Applications such as THz imaging and spectroscopy have the potential to provide continuous, real-time physiological information via dynamic, non-invasive, contactless measurements for future digital health technologies. Simultaneous localization and mapping (SLAM) methods will not only enable advanced cross reality (XR) applications but also enhance the navigation of autonomous objects such as vehicles and drones. Further in terrestrial and non-terrestrial networks, the measured channel data and sensing and positioning data can be obtained by the large bandwidth, new spectrum, dense network and more light-of-sight (LOS) links. Based on these data, a radio environmental map can be drawn through AI/ML methods, where channel information is linked to its corresponding positioning or environmental information to provide an enhanced physical layer design based on this map.

Sensing coordinators are nodes in a network that can assist in the sensing operation. These nodes can be standalone nodes dedicated to just sensing operations or other nodes (for example TRP 170, ED 110, or core network node) doing the sensing operations in parallel with communication transmissions. A new protocol and signaling mechanism is needed so that the corresponding interface link can be performed with customized parameters to meet particular requirements while minimizing signaling overhead and maximizing the whole system spectrum efficiency.

AI/ML and sensing methods are data-hungry. In order to involve AI/ML and sensing in wireless communications, more and more data are needed to be collected, stored, and exchanged. The characteristics of wireless data expand quite large ranges in multiple dimensions, e.g., from sub-6 GHz, millimeter to Terahertz carrier frequency, from space, outdoor to indoor scenario, and from text, voice to video. These data collecting, processing and usage operations are performed in a unified framework or a different framework.

Control information is referenced in some embodiments herein. Control information may sometimes instead be referred to as control signaling, or signaling. In some cases, control information may be dynamically communicated, e.g. in the physical layer in a control channel, such as in a physical uplink control channel (PUCCH) or physical uplink shared channel (PUSCH) or physical downlink control channel (PDCCH). An example of control information that is dynamically indicated is information sent in physical layer control signaling, e.g. uplink control information (UCI) sent in a PUCCH or PUSCH or downlink control information (DCI) sent in a PDCCH. A dynamic indication may be an indication in a lower layer, e.g. physical layer/layer 1 signaling, rather than in a higher-layer (e.g. rather than in RRC signaling or in a MAC CE). A semi-static indication may be an indication in semi-static signaling. Semi-static signaling, as used herein, may refer to signaling that is not dynamic, e.g. higher-layer signaling (such as RRC signaling), and/or a MAC CE. Dynamic signaling, as used herein, may refer to signaling that is dynamic, e.g. physical layer control signaling sent in the physical layer, such as DCI sent in a PDCCH or UCI sent in a PUCCH or PUSCH.

As indicated above, in the QCL typeD parameter introduced in 5G NR, polarization direction was not considered.

In 5G new radio (NR) release 17 (R17) non-terrestrial network (NTN), per-cell indication of polarization type among left hand circular polarization (LH-CP), right hand circular polarization (RH-CP), and linear polarization is supported. In such a case, the SSBs in one cell are transmitted with the same polarization type (either LH-CP, RH-CP, or linear polarization). For a serving cell, the polarization type indication is provided in a system information block (SIB). An indication of base station polarization type may be used to aid in reducing blind detection at the UE.

In 5G NR R17 NTN, several functionalities were proposed to be adopted into the standard. A first functionality was a per-SSB/beam polarization type indication that could be selected from among LH-CP or RH-CP, or to transmit time division multiplexed (TDMed) even or odd SSBs with LH-CP or RH-CP, respectively. In this first functionality, each SSB or beam is assigned with one polarization type and the UE may be notified of the polarization type or the polarization type may be known to the UE, i.e. as a pre-defined default type. A second functionality is a polarization type indication that could be selected from among LH-CP or RH-CP reusing the existing QCL indication mechanism. In this second functionality, if a RS is QCLed to an SSB, the RS has the same polarization type as the SSB. A third functionality is a dynamic polarization type indication selected from among LH-CP or RH-CP for polarization-based multiplexing. In this third functionality, downlink channel information (DCI) is used to indicate a polarization type for scheduled PDSCH or PUSCH. None of the three proposed functionalities were accepted in the 5G NR R17 NTN standard, as satellites are incapable of changing polarization type dynamically or transmitting LH-CP and RH-CP simultaneously.

Limitations of the above discussed functionalities proposed for 5G NR include 1) the beam indication in terms of QCL typeD (spatial Rx parameter) in R15 and R16 did not consider polarization aspects, 2) polarization type indication in R17 NTN did not consider dual linear polarized antennas with two separate polarization directions, which are widely deployed at mmWave and mid-band frequency range, and 3) a lack of a mechanism for polarization direction selection or polarization direction mapping that may be used in connection with dual linear polarized antennas.

Some embodiments of the present disclosure provide methods to address one or more of the drawbacks mentioned above, and in particular to provide a method for polarization direction selection or polarization direction mapping, or both, for communication systems with dual linear polarized antennas.

In a co-pending application (Assignee Reference 92019493PCT01), the Assignee of both that application and the present application describes a method of implementing 2-port SSB to exploit dual-polarized antennas for reducing latency and/or overhead for beam-based initial access, especially for mmWave frequency bands. With such a 2-port SSB, each SSB-port is transmitted via one or more base station antenna over one polarization direction (e.g., −45 or +45 degree slant polarization direction) or over one polarization direction relative to a reference plane, for example the surface of the earth (e.g., vertical or horizontal polarization direction). The dual-polarized antennas at the base station may apply the same or different beamforming weights (e.g., same or different beams). For a case where the base station applies the same beamforming weight (e.g., same beam) on the base station antennas over two polarization directions, with a differentiation of polarization directions of base station antennas using 2-port SSB and such knowledge provided to the UE, the UE may be able to decouple the UE dual-polarized antennas and measure two UE receive beams simultaneously, as illustrated in FIG. 4. In this way, the latency for beam-based initial access may be reduced. It is worth noting that the base station and the UE are capable of transmitting and receiving with different beamforming weights using antennas over two polarization directions.

FIG. 4 illustrates a portion of a network 400 that includes a base station 405 and a UE 410. Three base station transmit beams 407a, 407b and 407c are shown. Each of the base station transmit beams 407a, 407b and 407c are shown to include two polarization directions indicated by the overlapping horizontal and vertical lines that are represented by the “+” symbol. The UE 410 is shown to have two concurrent receive beams over two polarization directions. A first beam 412a is shown to transmit or receive over vertical polarization direction (|) and a second beam 412b is shown to transmit or receive over horizontal polarization direction (−). The two polarization directions at the UE 410 may shift as the UE 410 changes its orientation or switches receiving panels or antennas. The two concurrent UE receive beams 412a and 412b may help reduce latency for UE-side beam sweeping during initial access procedure.

In another co-pending application (Assignee Reference 9423941PCT01), the Assignee of both that application and the present application describes a method to exploit dual-polarized antennas at the base station and the UE to enable early MIMO transmission during initial access or right after initial access, or both. In particular, a UE may be requested to report 2-port CSI measured from 2-port SSB and carried over PUSCH, for example Msg3-PUSCH. The 2-port SSB may be transmitted from dual-polarized antennas at the base station, i.e., each SSB-port corresponding to polarized antennas at the base station over one polarization direction (e.g., −45 or +45 degree slant polarization direction) or one polarization direction in relative to a reference plane (e.g., vertical or horizontal polarization direction in relative to the surface of the earth). The 2-port CSI may consist of rank indicator (RI), channel quality indicator (CQI) and precoding matrix indicator (PMI) mainly for single-user multiple input multiple output (MIMO) transmission, and/or per-SSB-port SINR report that reflects the quality/isolation of sub-channels (e.g., vertical polarization direction, horizontal polarization direction) to enable intra-UE multiplexing or inter-UE multiplexing of same signal/channels or different signal/channels.

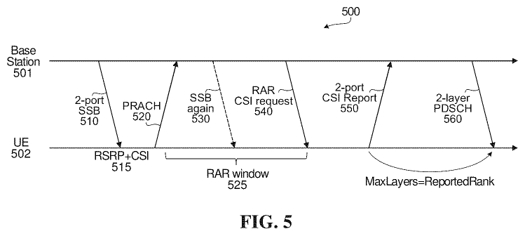

FIG. 5 illustrates an example of a signal flow diagram 500 for signaling that occurs between a base station 501 and a UE 502 that may reduce latency between SSB detection at the UE 502 and MIMO transmission by the base station 501 by using a CSI report transmitted over PUSCH or PUCCH as described in further detail in co-pending application Assignee Reference 9423941PCT01. The CSI report is associated with one or more SSBs transmitted over 2 antenna ports because the CSI report is determined based on measurement of the one or more 2-port SSBs. In step 510, the base station 501 transmits on at least one beam, one or more 2-port SSBs using dual-polarized antennas of the base station 501. At step 515, the UE 502 measures the reference signal received power (RSRP) of the one or more 2-port SSBs and may also generate a CSI report based on measurement of the one or more 2-port SSBs or the 2-port SSB associated with the PRACH transmission. The CSI report may be referred to as 2-port CSI report as the CSI report is based on measurement of the one or more 2-port SSBs or the 2-port SSB associated with the PRACH transmission. In step 520, the UE 502 transmits a random access preamble on a physical random access channel (PRACH) to the base station 501. In some implementations, the base station 501 may periodically transmit, on at least one beam, the one or more 2-port SSBs using dual-polarized antennas of the base station 501. Such periodic transmission of the one or more 2-port SSB(s) may occur again, as shown in step 530, within a random access response (RAR) window 525 or within a time period between transmission of the PRACH and reception of a request for a CSI report that is transmitted by the base station 501 at step 540. In step 540, the base station 501 transmits a request to the UE 502 for a CSI report. Upon receiving the request for a CSI report, the UE 502, in step 550, transmits a response to the CSI report request. In step 560, after the base station 501 receives the CSI report, the base station 501 enables multi-layer transmission to the UE 502.

Some embodiments of the present disclosure are directed to use of configuration information in the form of a quasi-co-polarization direction association between one or more RS(s) or channel(s) to assist the UE to match polarization direction to that of the base station for DL reception or UL transmission, or both. Such configuration information may be transmitted from the base station to the UE. The one or more RS(s) and channel(s) may include, but are not limited to, SSB, CSI-RS, PDCCH, PDSCH, PUCCH, PUSCH, SRS, and PRACH. As there may be multiple RS(s) or channel(s) of the same kind with a need to distinguish between them, the RS(s) or channel(s) of the same kind may be alternatively referred to as RS resources or channel resources with different resource indices. As one RS resource or channel resource may be transmitted over one or multiple antenna ports, the quasi-co-polarization direction association may be from RS or channel resource to RS or channel resource, antenna port to antenna port, antenna port to RS or channel resource, or RS or channel resource to antenna port. In particular, when a first RS or channel, considered as a source RS or channel, and a second RS or channel, considered as a target RS or channel to be associated with the source RS or channel, in the quasi-co-polarization direction association, are transmitted over multiple antenna ports, the antenna ports may be categorized into antenna port groups and to introduce a quasi-co-polarization direction association indication or mapping from antenna-port-group to antenna-port or from antenna-port-group to antenna-port-group or from antenna-port to antenna-port-group.

It is to be understood that the PDCCH, PDSCH, PUCCH, and PUSCH may be replaced with DMRS for PDCCH, DMRS for PDSCH, DMRS for PUCCH, and DMRS for PUSCH, respectively.

In some embodiments, a new parameter, is provided for transmission from a base station to a UE to indicate polarization direction reference information with respect to dual linearly polarized antennas with two polarization directions. The parameter used to indicate polarization direction reference information may be considered as a new QCL type and may, for example, be referred to as QCL typeE for polarization direction. However, the previous statement is not intended to limit the scope or implementation of the present disclosure, but is used as another manner to understand the concept being described. For the sake of simplicity, but not to limit the disclosure, the association in terms of polarization direction indicated by the polarization direction reference information may be abbreviated as quasi co-polarization-direction (QCPD) or quasi co-location of polarization direction (QCL-PD), and will be referred to as such in this disclosure.

For a particular scenario of CSI-RS being considered a target RS and SSB being considered a source RS, a polarization direction association indication is provided for a CSI-RS resource by referring to an SSB resource or an SSB-port of an SSB resource. Upon reception of configuration information from the base station including the polarization direction association indication, the UE may assume that the CSI-RS resource is transmitted by the base station with same or similar polarization direction(s) as the SSB resource or the SSB-port of the SSB source. Therefore, the UE may receive the CSI-RS resource following a similar reception behavior as for receiving the SSB resource or the SSB-port of the SSB resource. Three examples of providing polarization direction association indication will now be described. It is to be understood that other manners of providing the polarization direction association indication that are not explicitly described herein may be within the scope of the present disclosure.

In a first example, a X-port CSI-RS resource (e.g., for time/frequency tracking or CSI/beam measurement/report), where X=1, 2, . . . , N(N is a positive integer), may be configured as QCPDed to a 2-port SSB resource. Such a configuration may be used when two reported per-SSB-port-SINR(s) for the 2-port SSB resource are both above a certain threshold. In some embodiments, this scenario may occur when transmit polarization directions at the base station and receive polarization directions at the UE are well matched, for example, when the base station and the UE are both transmitting and receiving the two antenna ports of a 2-port SSB resource via vertical and horizontal polarization directions in relation to the surface of the earth and the wireless propagation channel is also in line-of-sight condition.

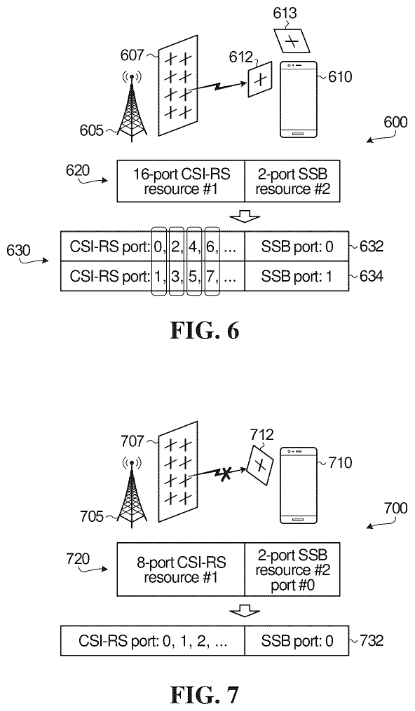

In this first example, to reduce signaling overhead for a per-port QCPD indication, pre-defined rules may be utilized. In some embodiments, when a X-port CSI-RS resource is configured as QCPDed to a 2-port SSB resource, the UE may assume that any even-indexed CSI-RS ports are QCPDed to port #0 of the SSB resource and the odd-indexed CSI-RS ports are QCPDed to port #1 of the SSB resource. In some embodiments, the port #0 of the SSB resource may be transmitted via vertically polarized antennas at the base station or via vertical polarization direction relative to the surface of the earth, and the port #1 of the SSB resource may be transmitted via horizontally polarized antennas at the base station or via horizontal polarization direction relative to the surface of the earth. In some embodiments, when a X-port CSI-RS resource is configured as QCPDed to a 2-port SSB resource, the UE may assume that first half of the indexed CSI-RS ports are QCPDed to port #0 of the SSB resource and second half of the indexed CSI-RS ports are QCPDed to port #1 of the SSB resource. In some embodiments, the port #0 of the SSB resource may be transmitted via vertically polarized antennas at the base station or via vertical polarization direction relative to the surface of the earth and the port #1 of the SSB resource may be transmitted via horizontally polarized antennas at the base station or horizontal polarization direction relative to the surface of the earth. It is also to be understood that port #0 of the SSB resource and port #1 of the SSB resource in the previous embodiment may be switched. While the mapping relation between even or odd-indexed SSB/CSI-RS ports to vertical or horizontal polarization directions are indicated above to have a particular relation, it is to be understood that the vertical or horizontal polarization directions may be switched (e.g., even-indexed or first half of the indexed SSB/CSI-RS ports correspond to horizontal polarization direction and odd-indexed or second half of the indexed SSB/CSI-RS ports correspond to vertical polarization direction). In some embodiments, the mapping relation between even or odd-indexed SSB/CSI-RS ports to vertical or horizontal polarization directions may be configured by the base station. A rule-based antenna port grouping and mapping for polarization direction association indication is illustrated in FIG. 6.

FIG. 6 illustrates an example portion of a network 600 that includes a base station 605 and a UE 610. The base station 605 is shown to include an antenna panel 607 that includes dual-polarized antennas, i.e. with two polarization directions including a vertical polarization direction indicated by the “|” symbol and a horizontal polarization direction indicated by the “−” symbol, that collectively are shown as a “+” symbol. The UE 610 is shown to include two antenna panels 612 and 613 that includes dual-polarized antennas. First antenna panel 612 of the UE 610 is shown to have polarization directions that are well matched with polarization directions of the antenna panel 607 of the base station 605. Second antenna panel 613 of the UE 610 does not have polarization directions well-matched with polarization directions of the antenna panel 607 of the base station 605 at this instance of time. However, if the UE 610 were to reorient itself, the second antenna panel 613 may be more well-matched to the polarization directions of the antenna panel 607 of the base station 605 at another instance of time. Furthermore, both the first antenna panel 612 and the second antenna panel 613 may be used together to receive signals from, or transmit signals to, the base station 605.

FIG. 6 also includes tabular representations 620, 630 of the polarization direction association. The base station 605 may provide a polarization direction association indication for a 16-port CSI-RS resource referring to a 2-port SSB resource as shown by 620. A more detailed view of polarization direction association between the CSI-RS ports of the CSI-RS resource and the SSB ports of the SSB resource is also shown by 630 in which even numbered CSI-RS ports are associated with SSB port #0 632, of the SSB resource #2 and odd numbered CSI-RS ports are associated with SSB port #1 634, of the SSB resource #2. As indicated above, alternative associations may include a first half of the CSI-RS ports associated with SSB port #0 and a second half of the CSI-RS ports associated with SSB port #1. Furthermore, the example of a 16-port CSI-RS resource is merely an example and more generally L-port CSI-RS resource, where L is an integer, may be considered.

In some embodiments, the base station may send configuration information that indicates a co-location relation among dual-polarized antennas at the base station. As an example, the base station may notify the UE that each CSI-RS port corresponds to one or multiple base station polarized antenna(s), and adjacent even and odd-indexed CSI-RS ports (e.g., port #0 and port #1, port #2 and port #3, etc.,) are transmitted from co-located dual-polarized antennas at the base station. For example, when each CSI-RS port corresponds to one base station polarized antenna, the two base station antennas corresponding to CSI-RS port #0 and port #1 are superposed with the same center location, but have approximately 90 degree offset in orientation direction or polarization direction. For example, when each CSI-RS port corresponds to multiple base station polarized antennas, the two groups of base station antennas corresponding to CSI-RS port #0 and port #1 are superposed with the same center locations (the first antenna in the first group is superposed with the first antenna in the second group, and so on), but have approximately 90 degree offset in orientation direction or polarization direction. In some embodiments, such configuration information may be included as part of a polarization direction association indication for a CSI-RS, or some other reference signal or channel.

In some embodiments, the polarization direction association indication for a CSI-RS resource referring to an SSB resource may enable the UE to reuse measurement results or reception behavior of the SSB resource, or both, to reduce UE complexity for CSI-RS measurement. In particular, the polarization direction association indication may provide the UE with knowledge of a polarization type or polarization direction(s), or both, and potentially a co-location relation among base station antennas for transmitting the CSI-RS resource. This may be helpful for the UE to determine how to receive and process CSI-RS utilizing the UE's own dual-polarized antennas. Furthermore, with this additional knowledge of base station polarization direction(s) and antenna placement provided to the UE, the CSI measurement accuracy at the UE may also be improved.

In a second example, a X-port CSI-RS resource (e.g., for time/frequency tracking or CSI/beam measurement/report), where X=1, 2, . . . , M(M is a positive integer), may be configured as QCPDed to 1 SSB port in a 2-port SSB resource. Such a configuration may be used when only one of two reported per-SSB-port-SINR(s) from the 2-port SSB resource is above a certain threshold. In some embodiments, this scenario may occur when one polarization direction at the UE is perpendicular to the transmit polarization plane at the base station, while the other polarization direction at the UE is still aligned or in parallel with the transmit polarization plane at the base station, under a line-of-sight channel condition. In some embodiments, this scenario may occur under a non-line-of-sight channel condition, where the polarization direction of one transmitted SSB port is changed during reflection of the signal and becomes perpendicular to the receive polarization plane at the UE, while the polarization direction of the other SSB port is still roughly aligned or in parallel with the receive polarization plane at the UE.

In this second example, the UE may assume that all CSI-RS ports in the CSI-RS resource are QCPDed to the indicated SSB port of the SSB resource. In some embodiments, the UE may assume all CSI-RS ports in the CSI-RS resource are transmitted over the same or similar polarization direction as the indicated SSB port of the SSB resource (e.g., over vertically or horizontally or −45 or +45 degree slantingly polarized antennas at the base station or vertical or horizontal polarization direction in relation to the surface of the earth). In some embodiments, the UE may perform CSI-RS reception or measurement, or both, using antennas corresponding to the indicated polarization direction only (e.g., the UE antennas with reported per-SSB-port SINR above a certain threshold) and turn off other antennas. In this way, measurement complexity and power consumption at the UE may be reduced. In some embodiments, such QCPD association between a CSI-RS resource and an SSB port of an SSB resource may be used to address changes of polarization plane or polarization direction matching or changes of isolation level between polarized sub-channels that may occur during UE movement or rotation, or both. In some embodiments, the base station may provide an update of the QCPD association to the UE when appropriate. For example, an 8-port CSI-RS resource that was previously QCPDed to port #0 of one SSB resource may be indicated to be updated as QCPDed to port #1 of the same, or a different SSB resource, after the UE rotates or moves location, or both.

FIG. 7 illustrates an example portion of a network 700 that includes a base station 705 and a UE 710. The base station 705 is shown to include an antenna panel 707 that includes dual-polarized antennas. The UE 710 is shown to include a single antenna panel 712 that includes dual-polarized antennas. The UE antenna panel 712 of the UE 710 is shown to have polarization directions that are not well-matched with polarization directions of the antenna panel 707 of the base station 705 at this instance of time.

FIG. 7 also includes tabular representations 720, 732 of the polarization direction association. The base station 705 may provide a polarization direction association indication for an 8-port CSI-RS resource referring to a single port of a 2-port SSB resource as shown by 720. A more detailed view of polarization direction association between the CSI-RS ports of the CSI-RS resource and the SSB port of the SSB resource is also shown by 732 in which all CSI-RS ports are associated with SSB port #0, of the SSB resource #2. It is to be understood that the example of the 8-port CSI-RS resource is merely an example and more generally P-port CSI-RS resource, where P is an integer, may be considered.

In a third example, a 1-port CSI-RS resource (e.g., for time/frequency tracking or CSI/beam measurement/report) may be configured as QCPDed to a 2-port SSB resource. Such a configuration may be used when the two reported per-SSB-port-SINR(s) from the 2-port SSB are varying, i.e. increasing and decreasing, and the SSB port that has the larger valued per-SSB-port-SINR is alternating over time. This may occur when the UE is rotating. With such polarization direction association indication received from the base station, the UE may assume that the 1-port CSI-RS resource is transmitted from dual polarized antennas at the base station. To be specific, the base station transmits the same signal of the 1-port CSI-RS resource over base station antennas over both polarization directions. In some embodiments, the UE may also receive this 1-port CSI-RS resource by combining or comparing the signals received from the UE's own dual-polarized antennas. In some embodiments, the polarization direction association indication enables a fallback transmission mode which may provide extra robustness against polarization plane or polarization direction mismatch due to UE rotation or movement, or both.

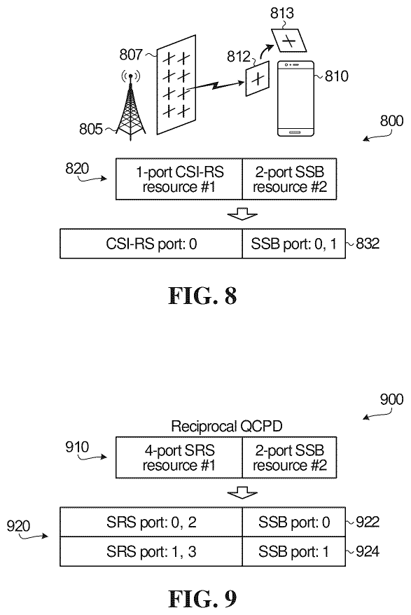

FIG. 8 illustrates an example portion of a network 800 that includes a base station 805 and a UE 810. The base station 805 is shown to include an antenna panel 807 that includes dual-polarized antennas. The UE 810 is shown to include two antenna panels 812 and 813 that each include dual-polarized antennas. First antenna panel 812 of the UE 810 is shown to have polarization directions well matched with polarization directions of the antenna panel 807 of the base station 805. Second antenna panel 813 of the UE 810 does not have polarization directions well-matched with polarization directions of the antenna panel 807 of the base station 805 at this instance of time.

FIG. 8 also includes tabular representations 820, 832 of the polarization direction association. The base station 805 may provide a polarization direction association indication for a 1-port CSI-RS resource by referring to a 2-port SSB resource, which includes 2 SSB ports as shown by 820. A more detailed view of polarization direction association between the 1-port CSI-RS resource and the 2-port SSB resource is also shown by 832 in which the 1-port CSI-RS resource is associated with both of the two SSB ports, SSB port #0 and SSB port #1, of the SSB resource #2.

The examples above mostly focus on the QCPD indication utilizing an association between CSI-RS and SSB. More generally, the QCPD indication indicates an association between a first resource with at least 1 port and a second resource with at least 1 port or between a first resource with at least 1 port and a first port of a second resource with at least 1 port. In some embodiments, the first resource is one of a CSI-RS, a PDCCH, a PDSCH, a PUCCH, a PUSCH, a SRS, or a PRACH. In some embodiments, the second resource is one of an SSB, CSI-RS, SRS, or PRACH, and wherein the SSB may comprise one or more of primary synchronization signal (PSS), secondary synchronization signal (SSS), physical broadcast channel (PBCH), and demodulation reference signal (DMRS) for PBCH.

Furthermore, it is to be understood that aspects of the disclosure may also be extended to other downlink DL signals or channels, or both, and other uplink (UL) signals or channels, or both. Therefore, in some embodiments, the QCPD association may be reciprocal, i.e., a target UL signal or channel is QCPDed with a source DL signal or channel, a target DL signal or channel is QCPDed with a source UL signal or channel.

In some embodiments, a QCPD association may be identified between PDSCH and at least one of SSB or CSI-RS. For example, an X-port (where X is an integer greater than 1) PDSCH-DMRS and an associated X-layer PDSCH may be configured as QCPDed to a 2-port SSB or CSI-RS resource. In some embodiments, the UE may assume even-indexed PDSCH-DMRS ports or odd-indexed PDSCH-DMRS ports and associated PDSCH layers are transmitted via base station antennas with the same polarization direction (e.g., vertical or horizontal polarization direction) as port #0 or port #1 of the indicated SSB or CSI-RS resource, respectively. In some embodiments, the UE may assume 1st half or 2nd half PDSCH-DMRS ports and associated PDSCH layers are transmitted via base station antennas with the same polarization direction (e.g., vertical or horizontal polarization direction) as port #0 or port #1 of the indicated SSB or CSI-RS resource, respectively.

In some embodiments, a Y-port PDSCH-DMRS and associated Y-layer PDSCH (where Y is an integer great than or equal to 1) may be configured as QCPDed to 1 port from a 2-port SSB or CSI-RS resource, where the UE may assume the Y-port PDSCH-DMRS and associated PDSCH layer(s) are transmitted via base station antennas with the same polarization direction (e.g., vertical or horizontal polarization direction) as the indicated port of the SSB or CSI-RS resource.

In some embodiments, a 1-port PDSCH-DMRS and associated 1-layer PDSCH may be configured as QCPDed to both antenna ports from a 2-port SSB or CSI-RS resource, where the UE may assume the 1-port PDSCH-DMRS and associated PDSCH layer is transmitted via base station antennas over both polarization directions (e.g., vertical and horizontal polarization directions, −45 and +45 degree slant polarization directions) as the indicated SSB or CSI-RS resource. Such a QCPD indication may assist the UE to match polarization directions with the base station during PDSCH reception and reduce detection complexity at the UE.

More generally, in some embodiments, the QCPD is an indication of polarization direction for a resource with at least 1 port, in which the resource is one of CSI-RS, a PDCCH, a PDSCH, a PUCCH, a PUSCH, a SRS, a PRACH, or an SSB. In some embodiments, the resource with at least 1 port is a resource with L ports, where L is an integer, and even-indexed ports in the resource with L ports are transmitted or received via base station antennas or UE antennas on a first polarization direction, and odd-indexed ports in the resource with L ports are transmitted or received via the base station antennas or the UE antennas on a second polarization direction. In some embodiments, the resource with at least 1 port is a resource with M ports, where M is an integer, and a first half of ports in the resource with M ports are transmitted or received via base station antennas or UE antennas on a first polarization direction, and a second half of ports in the resource with M ports are transmitted or received via the base station antennas or the UE antennas on a second polarization direction. In some embodiments, the resource with at least 1 port is a resource with N ports, where N is an integer, and the ports in the resource with N ports are transmitted or received via base station antennas or UE antennas on a first polarization direction. In some embodiments, the resource with the at least 1 port is a resource with 1 port, and the resource with 1 port is transmitted or received via base station antennas or UE antennas on two polarization directions.

In some embodiments, there is provided a reciprocal QCPD association between PUCCH or PUSCH or SRS or PRACH and SSB or CSI-RS, or between SSB or CSI-RS or PDCCH or PDSCH and SRS or PRACH. For example, an X-port PUSCH-DMRS and associated X-layer PUSCH or an X-port PUCCH-DMRS and associated X-layer PUCCH or an X-port SRS (where X is an integer greater than 1) may be configured as reciprocally QCPDed to a 2-port SSB or CSI-RS resource, where the UE may assume even-indexed PUSCH-DMRS ports or odd-indexed PUSCH-DMRS ports (or 1^{st} half PUSCH-DMRS ports or 2nd half PUSCH-DMRS ports) and associated PUSCH layers or even-indexed PUCCH-DMRS ports or odd-indexed PUCCH-DMRS ports (or 1^{st} half PUCCH-DMRS ports or 2nd half PUCCH-DMRS ports) and associated PUCCH layers or even-indexed SRS ports or odd-indexed SRS ports (or 1^{st} half SRS ports or 2nd half SRS ports) are received via base station antennas with the same polarization direction (e.g., vertical or horizontal polarization direction, −45 or +45 degree slant polarization direction) as that for transmitting the port #0 or port #1 of the indicated SSB or CSI-RS resource, respectively.

In some embodiments, a Y-port PUCCH-DMRS or PUSCH-DMRS and associated Y-layer PUCCH or PUSCH (where Y is an integer greater than or equal to 1) may be configured as reciprocally QCPDed to 1 port from a 2-port SSB or CSI-RS resource, where the UE may assume the Y-port PUCCH-DMRS or PUSCH-DMRS and associated PUCCH or PUSCH layer is received via base station antennas with the same polarization direction (e.g., vertical or horizontal polarization direction, −45 or +45 degree slant polarization direction) as that for transmitting the indicated port of the SSB or CSI-RS resource.

In some embodiments, a 1-port PUCCH-DMRS or PUSCH-DMRS and associated 1-layer PUCCH or PUSCH may be configured as reciprocally QCPDed to both antenna ports in a 2-port SSB or CSI-RS resource, where the UE may assume the 1-port PUCCH-DMRS or PUSCH-DMRS and associated PUCCH or PUSCH layer is received via base station antennas over both polarization directions as both polarization directions are used for transmitting the indicated 2-port SSB or CSI-RS resource. Such reciprocal QCPD indication may assist the UE in matching polarization direction with the base station during PUCCH or PUSCH or SRS or PRACH transmission and reduce detection complexity at the base station. Instead of indicating receiving polarization direction(s) at the base station, the reciprocal QCPD association may alternatively indicate the transmission polarization direction(s) at the UE. To be specific, the UE may transmit part or all antenna ports of the target signal or channel (e.g., PUCCH, PUSCH, SRS, PRACH) with corresponding polarization direction as that for receiving part or all antennas ports in the source SSB or CSI-RS resource.

In some embodiments, instead of replacing typeD QCL indication, a QCPD indication or typeE QCL indication may refer to polarization domain only and be configured by the base station in addition to the typeD QCL indication. For example, QCPD indication or typeE QCL indication may be configured as one of {port #0/1 interleaving, port #0-only, port #1-only, both port #0&1}, where port #0 and port #1 may correspond to −45 and +45 degree slant polarization directions or vertical and horizontal polarization directions relative to the surface of the earth, respectively. After a UE is notified with one of the QCPD or typeE QCL relations, the UE may assume the target resource is QCPDed to the source resource following the indicated relation (e.g., even/odd-indexed port association, resource-to-port association, port-to-resource association). For example, QCPD indication or typeE QCL indication may be configured as one= {V/H interleaving, V-only, H-only, both V&H}, where V and H correspond to vertical and horizontal polarization directions relative to the surface of the earth, respectively.

FIG. 9 illustrates tabular representations 910, 920 of an example of a reciprocal QCPD association 910 between a 4-port SRS resource and a 2-port SSB resource. A more detailed view of the reciprocal QCPD association between the 4-port SRS resource and the 2-port SSB resource is shown as 920 where even-indexed SRS ports #0 and #2 are associated with SSB port #0 as shown by 922 and odd-indexed SRS ports #1 and #3 are associated with SSB port #1 as shown by 924. Furthermore, the example of a 4-port SRS resource is merely an example and more generally Z-port SRS resource, where Z is an integer, may be considered.

In some embodiments, aspects of the present disclosure may result in reduced UE complexity for selecting dual polarized antennas for DL reception or UL transmission.

In some embodiments, aspects of the present disclosure may result in improved CSI measurement accuracy and DL detection performance at the UE with more knowledge of base station polarization direction(s) and antenna architecture.

In some embodiments, aspects of the present disclosure may result in reduced base station and UE power consumption with only selected polarized antenna(s) to transmit or receive.

In some embodiments, aspects of the present disclosure may result in on-demand extra robustness against polarization mismatch from UE rotation when needed.

While embodiments described above show examples directed to SSB being used for beam measurement, it should be understood that the concepts disclosed herein can be extended to other types of reference signals for beam measurement, such as CSI-RS, tracking reference signal (TRS), and positioning reference signal (PRS).

While the embodiments described above show examples directed to dual-polarized antennas with vertical/horizontal polarization directions, it should be understood that the concepts disclosed herein can be extended to dual-polarized antennas with ±45 degree slant polarization directions.

While the embodiments described above show examples directed to dual-polarized antennas with 90 degree offset in polarization direction (i.e., vertical/horizontal polarization directions, +45 degree slant polarization directions), it should be understood that the concepts disclosed herein can be extended to dual-polarized antennas with a non-90 offset in polarization direction (e.g., 60 degree) or multi-polarized antennas (e.g., 3 polarization directions with 0, 45, 90 degrees).

While the embodiments described above show examples directed to 2 polarization directions, it should be understood that the concepts disclosed herein can be extended to other antenna architectures that can be considered as equipped with more than 2 polarization directions (e.g., 3, 4, 5, 6, 7, 8).

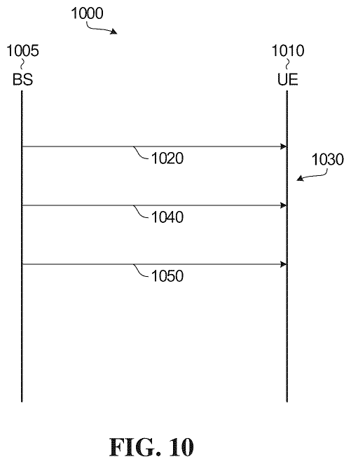

FIG. 10 illustrates an example of a signal flow diagram for transmission of configuration information related to the polarization direction association indication between a base station 1005 and a UE 1010, in accordance with embodiments of the present disclosure.

At step 1020, the base station 1005 may transmit to the UE 1010 configuration information that includes a QCPD association indication. While FIG. 10 illustrates that the configuration information is transmitted from the base station 1005 to the UE 1010, the base station 1005 may transmit the configuration information in a broadcast manner to more than one UE. Note that polarization direction association and QCPD association are used inter-changeably throughout the present disclosure.

The information conveyed by the configuration information may include an association between a first resource with at least 1 port and a second resource with at least 1 port or between a first resource with at least 1 port and a first port of a second resource with at least 1 port. In some embodiments, the first resource is one of a CSI-RS, a PDCCH, a PDSCH, a PUCCH, a PUSCH, a SRS, or a PRACH. In some embodiments, the second resource is one of an SSB, CSI-RS, SRS, or PRACH, and wherein the SSB may comprise one or more of primary synchronization signal (PSS), secondary synchronization signal (SSS), physical broadcast channel (PBCH), and demodulation reference signal (DMRS) for PBCH.

Still referring to FIG. 10, upon reception of the configuration information from the base station in step 1020 including the polarization direction association indication, at step 1030, the UE 1010 may assume that the first resource with at least 1 port is transmitted by the base station 1005 with same or similar polarization direction(s) as the second resource with at least 1 port or the first port of the second resource with at least 1 port.

At step 1040, the base station 1005 transmits the second resource with at least 1 port or the first port of the second resource with at least 1 port. At step 1050, the base station 1005 transmits the first resource with at least 1 port. Based on the received configuration information at step 1020, the UE 1010 is prepared to be able to receive the first resource with at least 1 port based on the polarization direction association indication.

While one or more steps of the methods described above are based on dual-polarized antennas with vertical or horizontal polarization directions, or both, it should be understood that the methods may be performed using dual-polarized antennas with ±45 degree slant polarization directions. Similarly, while one or more steps of the methods described above are based on dual-polarized antennas with 90 degree offset in polarization direction (i.e. vertical/horizontal polarization directions, +45 degree slant polarization directions), it should be understood that the methods may be performed using dual-polarized antennas with a non-90 degree offset (e.g. 60 degree) in polarization direction. Furthermore, while one or more steps of the methods described above are based on dual-polarized antennas with two polarization directions, it should be understood that the methods may be performed using antenna structures or architectures that may be considered such that the network device or the apparatus is equipped with antennas capable of transmitting or receiving over M polarization directions, where M is an integer greater than 2. In this case, the 2-port SSB or CSI-RS resource mentioned in embodiments or examples illustrated above or elsewhere in the present disclosure may be replaced as M-port SSB or CSI-RS resource.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the figures or all of the portions schematically shown in the figures. Moreover, selected features of one example embodiment may be combined with selected features of other example embodiments.

While this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

1. A method comprising:
receiving an indication of a quasi co-polarization-direction (QCPD) association, wherein the QCPD association is between a first resource with at least 1 port and a second resource with at least 1 port, or the QCPD association is between the first resource with at least 1 port and a first port of the second resource with at least 1 port; and
wherein the first resource is one of a channel state information reference signal (CSI-RS), a physical downlink control channel (PDCCH), a physical downlink shared channel (PDSCH), a physical uplink control channel (PUCCH), a physical uplink shared channel (PUSCH), a sounding reference signal (SRS), or a physical random access channel (PRACH); and
wherein the second resource is one of a synchronization signal-physical broadcast channel block (SSB), a second CSI-RS, a second SRS, or a second PRACH, and wherein the SSB comprises one or more of a primary synchronization signal (PSS), a secondary synchronization signal (SSS), a physical broadcast channel (PBCH), or a demodulation reference signal (DMRS) for the PBCH.

2. The method of claim 1, wherein the first resource is with X ports, wherein X is an integer, and wherein the second resource is with 2 ports.

3. The method of claim 2, wherein the QCPD association between the first resource with X ports and the second resource with 2 ports further indicates at least one of:
even-indexed ports of the first resource with X ports being transmitted or received with a same polarization direction of the first port of the second resource with 2 ports; or
odd-indexed ports of the first resource with X ports being transmitted or received with a same polarization direction of a second port of the second resource with 2 ports.

4. The method of claim 2, wherein the QCPD association between the first resource with X ports and the second resource with 2 ports further indicates at least one of:
a first half of ports of the first resource with X ports being transmitted or received with a same polarization direction of the first port of the second resource with 2 ports; or
a second half of ports of the first resource with X ports being transmitted or received with a same polarization direction of a second port of the second resource with 2 ports.

5. The method of claim 1, wherein the first resource is with Y ports, wherein Y is an integer, and wherein the first port of the second resource with at least 1 port is the first port of the second resource with 2 ports.

6. The method of claim 5, wherein the QCPD association between the first resource with Y ports and the first port of the second resource with 2 ports further indicates:
ports of the first resource with Y ports being transmitted or received with a same polarization direction of the first port of the second resource with 2 ports.

7. The method of claim 1, wherein the first resource is with 1 port, and the second resource is with 2 ports.

8. The method of claim 7, wherein the QCPD association between the first resource with 1 port and the second resource with 2 ports further indicates:
the first resource with 1 port being transmitted or received with same two polarization directions used for transmitting or receiving the second resource with 2 ports.

9. A device comprising:
one or more processors, when executing program instructions stored in the device, cause the device to:
receive an indication of a quasi co-polarization-direction (QCPD) association, wherein the QCPD association is between a first resource with at least 1 port and a second resource with at least 1 port, or the QCPD association is between the first resource with at least 1 port and a first port of the second resource with at least 1 port; and
wherein the first resource is one of a channel state information reference signal (CSI-RS), a physical downlink control channel (PDCCH), a physical downlink shared channel (PDSCH), a physical uplink control channel (PUCCH), a physical uplink shared channel (PUSCH), a sounding reference signal (SRS), or a physical random access channel (PRACH); and
wherein the second resource is one of a synchronization signal-physical broadcast channel block (SSB), a second CSI-RS, a second SRS, or a second PRACH, and wherein the SSB comprises one or more of a primary synchronization signal (PSS), a secondary synchronization signal (SSS), a physical broadcast channel (PBCH), or a demodulation reference signal (DMRS) for the PBCH.

10. The device of claim 9, wherein the first resource is with X ports, wherein X is an integer, and wherein the second resource is with 2 ports.

11. The device of claim 10, wherein the QCPD association between the first resource with X ports and the second resource with 2 ports further indicates at least one of:
even-indexed ports of the first resource with X ports being transmitted or received with a same polarization direction of the first port of the second resource with 2 ports; or
odd-indexed ports of the first resource with X ports being transmitted or received with a same polarization direction of a second port of the second resource with 2 ports.

12. The device of claim 10, wherein the QCPD association between the first resource with X ports and the second resource with 2 ports further indicates at least one of:
a first half of ports of the first resource with X ports being transmitted or received with a same polarization direction of the first port of the second resource with 2 ports; or
a second half of ports of the first resource with X ports being transmitted or received with a same polarization direction of a second port of the second resource with 2 ports.

13. The device of claim 9, wherein the first resource is with Y ports, wherein Y is an integer, and wherein the first port of the second resource with at least 1 port is the first port of the second resource with 2 ports.

14. The device of claim 13, wherein the QCPD association between the first resource with Y ports and the first port of the second resource with 2 ports further indicates:
ports of the first resource with Y ports being transmitted or received with a same polarization direction of the first port of the second resource with 2 ports.

15. The device of claim 9, wherein the first resource is with 1 port, and the second resource is with 2 ports.

16. The device of claim 15, wherein the QCPD association between the first resource with 1 port and the second resource with 2 ports further indicates:
the first resource with 1 port being transmitted or received with same two polarization directions used for transmitting or receiving the second resource with 2 ports.

17. A method comprising:
transmitting an indication of a quasi co-polarization-direction (QCPD) association, wherein the QCPD association is between a first resource with at least 1 port and a second resource with at least 1 port, or the QCPD association is between the first resource with at least 1 port and a first port of the second resource with at least 1 port; and
wherein the first resource is one of a channel state information reference signal (CSI-RS), a physical downlink control channel (PDCCH), a physical downlink shared channel (PDSCH), a physical uplink control channel (PUCCH), a physical uplink shared channel (PUSCH), a sounding reference signal (SRS), or a physical random access channel (PRACH); and
wherein the second resource is one of a synchronization signal-physical broadcast channel block (SSB), a second CSI-RS, a second SRS, or a second PRACH, and wherein the SSB comprises one or more of a primary synchronization signal (PSS), a secondary synchronization signal (SSS), a physical broadcast channel (PBCH), or a demodulation reference signal (DMRS) for the PBCH.

18. The method of claim 17, wherein the first resource is with X ports, wherein X is an integer, and wherein the second resource is with 2 ports.

19. A device comprising:
one or more processors, when executing program instructions stored in the device, cause the device to:
transmit an indication of a quasi co-polarization-direction (QCPD) association, wherein the QCPD association is between a first resource with at least 1 port and a second resource with at least 1 port, or the QCPD association is between the first resource with at least 1 port and a first port of the second resource with at least 1 port; and
wherein the first resource is one of a channel state information reference signal (CSI-RS), a physical downlink control channel (PDCCH), a physical downlink shared channel (PDSCH), a physical uplink control channel (PUCCH), a physical uplink shared channel (PUSCH), a sounding reference signal (SRS), or a physical random access channel (PRACH); and
wherein the second resource is one of a synchronization signal-physical broadcast channel block (SSB), a second CSI-RS, a second SRS, or a second PRACH, and wherein the SSB comprises one or more of a primary synchronization signal (PSS), a secondary synchronization signal (SSS), a physical broadcast channel (PBCH), or a demodulation reference signal (DMRS) for the PBCH.

20. The device of claim 19, wherein the first resource is with X ports, wherein X is an integer, and wherein the second resource is with 2 ports.
